(19) United States
(12) Patent Application Publication
(10) Pub. No.: US 2017/0176761 A1
(43) Pub. Date: Jun. 22, 2017

(54) DISPLAY APPARATUS

(71) Applicant: Samsung Display Co., Ltd., Yongin-si (KR)

(72) Inventor: MINSOO KIM, Seoul (KR)

(21) Appl. No.: 15/376,326

(22) Filed: Dec. 12, 2016

(30) Foreign Application Priority Data
Dec. 16, 2015 (KR) 10-2015-0180347

(51) Int. Cl. G02B 27/28; G02B 7/00; G02B 26/02

(52) U.S. Cl. CPC G02B 27/281; G02B 26/023; G02B 7/00

(57) ABSTRACT

A display apparatus may include a display panel, a first polarizer, a second polarizer, and a driving part. The display panel may have a display surface and may display an image on the display surface. The first polarizer may be positioned on the display panel. The second polarizer may be positioned on the display panel and may overlap the first polarizer. The driving part may move the first polarizer in a first direction. The first direction may be parallel to the display surface.

### CROSS-REFERENCE TO RELATED APPLICATION

This application claims priority to and the benefit of Korean Patent Application No. 10-2015-0180347, filed on Dec. 16, 2015; the disclosure of the Korean Patent Application is incorporated by reference herein in its entirety.

### BACKGROUND

1. Field

The technical field is related to a display apparatus.

2. Description of the Related Art

A modern display apparatus, such as a plasma display apparatus, a liquid crystal display apparatus, or an organic light emitting display apparatus, may have advantages such as one or more of small size, light weight, and low-power-consumption. A transparent display apparatus may enable a user to simultaneously view a displayed image and an object positioned behind the transparent display apparatus. Quality and/or clarity of the displayed image may be significantly affected by the brightness of the environment in which the transparent display apparatus operates.

### SUMMARY

One or more embodiments may be related to a display apparatus capable of controlling light transmittance.

According to an embodiment, a display apparatus includes a transparent display panel configured to display an image on a surface that extends in a first direction and extends in a second direction perpendicular to the first direction. The transparent display panel may pass/transmit light provided by a source external to the display apparatus. The display apparatus includes a first polarizer disposed on the transparent display panel and configured to automatically move in the first direction. The display apparatus includes a second polarizer disposed on the transparent display panel and overlapping the first polarizer.

In an embodiment, the first polarizer may include a first plurality of first areas (i.e., first plurality of first-type portions) and a first plurality of second areas (i.e., first plurality of second-type portions) which are alternately disposed. The first polarizer may have a first first polarizing axis (i.e., first first-type polarizing axis) in the first plurality of first areas. The first polarizer may have a first second polarizing axis (i.e., first second-type polarizing axis) which is perpendicular to the first polarizing axis in the first plurality of second areas. The second polarizer may include a second plurality of first areas (i.e., second plurality of first-type portions) and a second plurality of second areas (i.e., second plurality of second-type portions) which are alternately disposed. The second polarizer may have a second first polarizing axis (i.e., second first-type polarizing axis) in the second plurality of first areas. The second polarizer may have a second second polarizing axis (i.e., second second-type polarizing axis) which is perpendicular to the second first polarizing axis in the second plurality of second areas.

In an embodiment, each of the first areas of the first polarizer may extend in the second direction. Each of the second areas of the first polarizer may be adjacent to the first area in the first direction and extends in the second direction.

In an embodiment, the first areas and the second areas of the first polarizer may be alternately arranged in the first direction and alternately arranged in the second direction, so that the first areas and the second areas are arranged in a checkerboard pattern.

In an embodiment, the display panel may include a plurality of pixels to display an image. The pixel may include a sub-pixel which emits light and a transmission window which passes the external light.

In an embodiment, a plurality of pixels which area arranged in the first direction may be disposed in the first area of the first polarizer.

In an embodiment, the pixel may include an organic light emitting structure and a thin film transistor which is electrically connected to the organic light emitting structure.

In an embodiment, movable range of the first polarizer may be substantially same as a width of the first area of the first polarizer in the first direction.

In an embodiment, the display apparatus may further include a driving part configured to move the first polarizer along the first direction.

In an embodiment, the driving part may include a roll and a driving motor configured to rotate the roll. The roll may be connected to an end of the first polarizer in the first direction, so that the end of the first polarizer is enrolled to the roll when the roll rotates to move the first polarizer in the first direction.

In an embodiment, the driving part may include a rack gear and a driving motor including a pinion gear which makes contact with the rack gear. The rack gear may be connected to an end of the first polarizer in the first direction, so that the rack gear moves in the first direction by rotation of the pinion gear.

In an embodiment, the first area of the first polarizer may be spaced apart from the second area of the first polarizer. A non-polarizing transparent area which does not have polarizing function may be formed between the first area and the second area.

In an embodiment, arrangement of the first and second areas of the first polarizer may be same as arrangement of the first and second areas of the second polarizer.

In an embodiment, the second polarizer may be attached on a rear surface of the display panel, and disposed between the first polarizer and the display panel.

In an embodiment, a plurality of transparent portions may be formed at the first and second polarizer.

In an embodiment, the transparent portions may be a plurality of openings formed at the first and second polarizer.

In an embodiment, the second polarizer may be attached on a front surface of the display panel. The display panel may be disposed between the first polarizer and the second polarizer.

In an embodiment, the display apparatus may further include a sensing unit for sensing strength of external light.

According to an embodiment, a display apparatus includes a transparent display panel configured to display an image on a surface that extends in a first direction and extends in a second direction perpendicular to the first direction. The transparent display panel may pass/transmit light provided by a source external to the display apparatus. The display apparatus may include a first polarizer disposed on the transparent display panel. The display apparatus may include a second polarizer disposed on the transparent display panel and overlapped with the first polarizer in the plane. The display apparatus may control light transmittance of the display apparatus by changing a relative position of the first polarizer and the second polarizer.

In an embodiment, the display apparatus may include a driving part for changing the relative position of the first polarizer and the second polarizer.

An embodiment may be related to a display apparatus. The display apparatus may include a display panel, a first polarizer, a second polarizer, and a driving part. The display panel may have a display surface and may display an image on the display surface. The first polarizer may be positioned on the display panel. The second polarizer may be positioned on the display panel and may overlap the first polarizer. The driving part may move the first polarizer in a first direction. The first direction may be parallel to the display surface.

The first polarizer may include first-polarizer first-type portions and first-polarizer second-type portions. The first-polarizer first-type portions and the first-polarizer second-type portions may be alternately positioned. Polarizing axes of the first-polarizer first-type portions may be perpendicular to polarizing axes of the first-polarizer second-type portions. The second polarizer may include second-polarizer first-type portions and second-polarizer second-type portions. The second-polarizer first-type portions and the second-polarizer second-type portions may be alternately positioned. Polarizing axes of the second-polarizer first-type portions may be perpendicular to polarizing axes of the second-polarizer second-type portions.

A first subset of the first-polarizer first-type portions and a first subset of the first-polarizer second-type portions may be alternately positioned along the first direction.

A second direction may be parallel to the display surface and may be perpendicular to the first direction. A second subset of the first-polarizer first-type portions and a second subset of the first-polarizer second-type portions may be alternately positioned along the second direction.

The first-polarizer first-type portions and the first-polarizer second-type portions may be alternately arranged in a checkerboard pattern.

A second direction may be parallel to the display surface and may be perpendicular to the first direction. The first-polarizer first-type portions may include a first first-polarizer first-type portion. A first edge of the first first-polarizer first-type portion may extend in the first direction. A second edge of the first first-polarizer first-type portion may extend in the second direction and may be longer than or as long as the first edge of the first first-polarizer first-type portion. The first-polarizer second-type portions may include a first first-polarizer second-type portion. A first edge of the first first-polarizer second-type portion may extend in the first direction. A second edge of the first first-polarizer second-type portion may extend in the second direction and may be longer than or as long as the first edge of the first first-polarizer second-type portion.

The second edge of the first first-polarizer second-type portion may be longer than the first edge of the first first-polarizer second-type portion.

No intervening polarizing portion may be positioned between the first first-polarizer second-type portion and the first first-polarizer first-type portion. The second edge of the first first-polarizer second-type portion may abut or may be spaced from the second edge of the first first-polarizer first-type portion.

The first first-polarizer second-type portion may have a transparent non-polarizing opening.

The display panel may include a pixel. The pixel may include light emitting structure and a transparent window. The light emitting structure may neighbor the transparent window in a plan view of the display apparatus. The non-polarizing opening may be positioned on the transparent window.

The second edge of the first first-polarizer second-type portion may be as long as the first edge of the first first-polarizer second-type portion.

The second edge of the first first-polarizer second-type portion may abut the second edge of the first first-polarizer first-type portion.

The second edge of the first first-polarizer second-type portion may be spaced from the second edge of the first first-polarizer second-type portion. No intervening polarizing portion may be positioned between the second edge of the first first-polarizer second-type portion and the second edge of the first first-polarizer first-type portion.

The display panel may include a pixel. The pixel may include light emitting structure and a transparent window. The light emitting structure may neighbor the transparent window in a plan view of the display apparatus. A non-polarizing opening may be positioned between the second edge of the first first-polarizer second-type portion and the second edge of the first first-polarizer first-type portion and may be positioned on the transparent window.

The display panel may include a pixel. The pixel may include light emitting structure and a transparent window. The light emitting structure may neighbor the transparent window in a plan view of the display apparatus. The first-polarizer first-type portions include a second first-polarizer first-type portion. No intervening polarizing portion may be positioned between the first first-polarizer first-type portion and the second first-polarizer first-type portion. A non-polarizing opening may be positioned between the first first-polarizer first-type portion and the second first-polarizer first-type portion and may be positioned on the transparent window.

The display panel may include a first pixel and a second pixel. The first pixel may include first light emitting structure and a first transparent window. The first light emitting structure may neighbor the first transparent window in a plan view of the display apparatus. The second pixel may include second light emitting structure and a second transparent window. The second light emitting structure may neighbor the second transparent window in a plan view of the display apparatus. The first first-polarizer first-type portion may have or abut a first non-polarizing opening. The first non-polarizing opening may be position on the first transparent portion. The first first-polarizer second-type portion may have or abut a second non-polarizing opening. The second non-polarizing opening may be position on the second transparent portion. The second edge of the first first-polarizer first-type portion and the second edge of the first first-polarizer second-type portion may be positioned between the first non-polarizing opening and the second non-polarizing opening in the plan view of the display apparatus.

The first first-polarizer first-type portion may be spaced from the first first-polarizer second-type portion. No intervening polarizing portion may be positioned between the first first-polarizer first-type portion and the first first-polarizer second-type portion.

The driving part may move the first polarizer within a range that is equal to a length of the first edge of the first first-polarizer first-type portion.

The driving part may bend and/or roll a portion of the first polarizer for moving the first polarizer.

The first polarizer may include a rack gear. The driving part may include a pinion gear. The pinion gear may directly contact (and engage) the rack gear.

The second polarizer may be positioned between the display panel and the first polarizer.

The display apparatus may include a sensing unit. The sending unit may be electrically connected to the driving part. The sensing unit may determine a light strength measurement associated with light received by the sensing unit. The driving part may be configured to move the first polarizer according to the light strength measurement.

According to embodiments, a display apparatus may include a display panel, a first polarizer and a second polarizer. The display panel may display an image. The display apparatus may control light transmittance of the display apparatus by changing a position of the first polarizer relative to the second polarizer. When external light is strong, the transmittance of the display apparatus may be decreased, so that visibility of the image displayed on the display apparatus may be optimized.

### BRIEF DESCRIPTION OF THE DRAWINGS

FIG. 1 is a conceptual perspective view illustrating a display apparatus according to an embodiment.

FIG. 2A, FIG. 2B, and FIG. 2C are plan views illustrating relative positions of a first polarizer and a second polarizer of the display apparatus of FIG. 1 according to an embodiment.

FIG. 3A is a cross-sectional view illustrating the display apparatus of FIG. 1 according to an embodiment.

FIG. 3B is a cross-sectional view illustrating a display apparatus according to an embodiment according to an embodiment.

FIG. 4 is a plan view illustrating relationship between first and second areas of a first polarizer and a pixel of a display panel of the display apparatus of FIG. 1 according to an embodiment.

FIG. 5 is a conceptual perspective view illustrating a driving part of a display apparatus according to an embodiment.

FIG. 6A and FIG. 6B are cross-sectional views illustrating an operation of the driving part of FIG. 5 according to an embodiment.

FIG. 7 is a conceptual perspective view illustrating a driving part of a display apparatus according to an embodiment.

FIG. 8A and FIG. 8B are cross-sectional views illustrating an operation of the driving part of FIG. 7 according to an embodiment.

FIG. 9A, FIG. 9B, and FIG. 9C are plan views illustrating relative positions of a first polarizer and a second polarizer of a display apparatus according to an embodiment.

FIG. 10A, FIG. 10B, and FIG. 10C are plan views illustrating relative positons of a first polarizer and a second polarizer of a display apparatus according to an embodiment.

FIG. 11A, FIG. 11B, and FIG. 11C are plan views illustrating relative positions of a first polarizer and a second polarizer of s display apparatus according to an embodiment.

### DETAILED DESCRIPTION

Embodiments are described with reference to the accompanying drawings. Although the terms “first”, “second”, etc. may be used herein to describe various elements, these elements, should not be limited by these terms. These terms may be used to distinguish one element from another element. Thus, a first element discussed below may be termed a second element without departing from teachings of one or more embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively. An “area” may mean a “portion” or “polarizing portion”. A “portion” may mean a “polarizing portion”. An “opening” may mean/be a “non-polarizing opening” or “non-polarizing portion”.

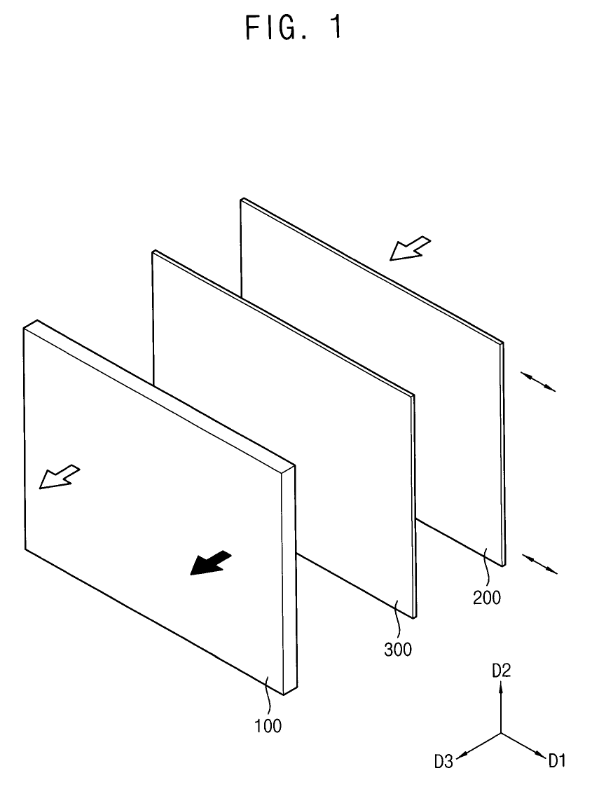

FIG. 1 is a conceptual perspective view illustrating a display apparatus according to an embodiment.

Referring to FIG. 1, the display apparatus may include a display panel 100, a first polarizer 200, and a second polarizer 300.

The display panel 100 may be a transparent display panel which can pass/transmit external light and can display an image. The display panel 100 may have a display surface for displaying the image. The display surface may extend in a first direction D1 and may extend in a second direction D2 different from the first direction D1. The second direction D2 may be substantially perpendicular to the first direction D1.

For example, the display panel 100 may include pixel structure to display an image, and a transmission window to pass external light. The pixel structure may include organic light emitting structure and a thin film transistor electrically connected to the organic light emitting structure. The organic light emitting structure may display an image by emitting light in a third direction D3 which is perpendicular to the directions D1 and D2. The transmission window may pass/transmit external light provided by a source external to the display apparatus, so that the display panel 100 may show an object positioned behind the display apparatus. Referring to FIG. 1, the display panel 100 may display an image (represented by a black arrow), and may pass the external light (represented by a white arrow)

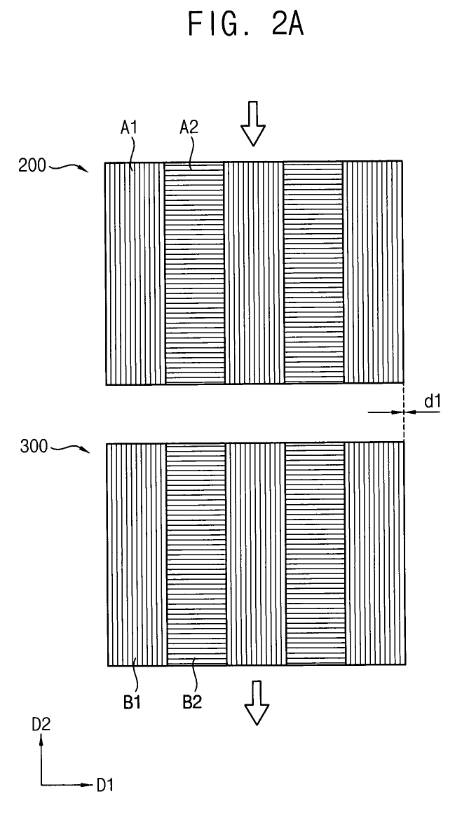

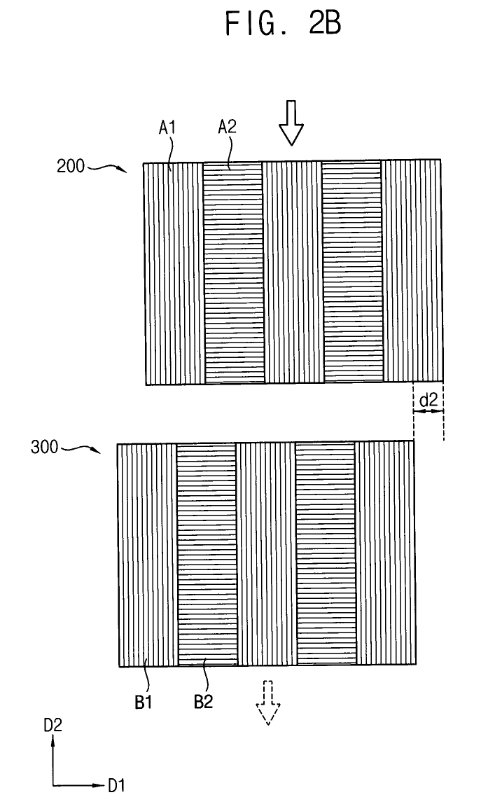

The first polarizer 200 may be disposed on a rear surface of the display panel 100. In an embodiment, the first polarizer 200 may be spaced apart from the display panel 100 in the third direction D3. The first polarizer 200 may include a plurality of first areas (referred to as A1 in FIG. 2A) and second areas (referred to as A2 in FIG. 2A) which are alternately disposed.

The second polarizer 300 may be disposed between the display panel 100 and the first polarizer 200. The second polarizer 300 may include a plurality of first areas (referred to as B1 in FIG. 2A) and second areas (referred to as B2 in FIG. 2A) which are alternately disposed.

The first polarizer 200 may move left and right along the first direction D1, so that relative position of the first polarizer 200 with reference to the second polarizer 300 may be changed. Accordingly, transmittance of external light by the display apparatus may be controlled.

According to an example embodiment, the display apparatus may include the display panel 100, the first polarizer 200 and the second polarizer 300. In an embodiment, before or when an image is displayed on the display panel 100, the display apparatus may control transmittance of the display apparatus for external light by changing the relative position of the first polarizer 200 with reference to the second polarizer 300. In an environment with strong external light, visibility of the image may be optimized by lowering the transmittance for external light.

For example, the display apparatus may be applied to a head-up display for a vehicle, e.g., a car. The display apparatus may be applied to a windshield of the car, so that recognition/perception of displayed images may be optimized amid external environment changes. The display apparatus may lower the transmittance of the display apparatus when the external light is strong, and the display apparatus may increase the transmittance of the display apparatus when the external light is weak.

FIGS. 2A, 2B, and 2C are a plan views illustrating positions of a first polarizer relative to a second polarizer in the display apparatus of FIG. 1 according to an embodiment. In embodiments, the first polarizer is positioned on a first plane, and the second polarizer is positioned on a second plane parallel to the first plane. For clearly illustrating relative positions, FIGS. 2A, 2B, and 2C and some other plan views may illustrate plan views of the first polarizer and the second polarizer on the same sheet/plane although the first polarizer and the second polarizer are positioned on separate planes.

In a configuration/operation of the display apparatus illustrated in FIG. 2A, transmittance of the display apparatus for external light is its maximum. Referring to FIG. 2A, light passing through the first polarizer 200 may be polarized. The first polarizer 200 may include a plurality of first areas A1 and a plurality of second areas A2. A/each first area A1 may extend in a second direction D2. The second direction D2 may be substantially perpendicular to the first direction D1. A/each second area A2 may directly contact/abut at least a first area A1 in the first direction D1, and may extend in the second direction D2. A width of a/each first area A1 may be substantially equal to a width of a/each second area A2 in the first direction D1.

The first polarizer 200 may have a first polarizing axis in the/each first area A1. The first polarizer 200 may have a second polarizing axis in the/each second area A2. The first polarizing axis may be perpendicular to the second polarizing axis. In an embodiment, direction of polarizing axis in the first area A1 and direction of polarizing axis in the second area A2 may differ by 90 degree. For example, when the first polarizing axis is 0 degree relative to the first direction D1, the second polarizing axis is 90 degree relative to the first direction D1.

Light passing the second polarizer 300 may be polarized. The second polarizer 300 may include a plurality of first areas B1 and a plurality of second areas B2. A/each first area B1 may extend in the second direction D2. A/each second area B2 may directly contact/abut at least a first area B1 in the first direction D1, and may extend in the second direction D2. A width of a/each first area B1 may be substantially equal to a width of a/each second area B2 in the first direction D1.

The second polarizer 300 may have a first polarizing axis in the/each first area B1. The second polarizer 300 may have a second polarizing axis in the/each second area B2. Sizes of areas A1, A2, B1, and B2 may be substantially identical to one another. Shapes of areas A1, A2, B1, and B2 may be substantially identical to one another.

In an embodiment, position difference (or displacement) of the first polarizer 200 relative to the second polarizer 300 in the first direction D1 may be, for example, d1 (equal to zero), d2 (greater than zero and less than a polarizing portion/area width), or d3 (equal to a polarizing portion/area width). In an embodiment, the first polarizer 200 and the second polarizer 300 may be disposed at a same position in the first direction D1. In an embodiment, the first areas A1 of the first polarizer 200 may substantially completely match and/or overlap the first areas B1 of the second polarizer 300, and the second areas A2 of the first polarizer 200 may substantially completely match and/or overlap the second areas B2 of the second polarizer 300.

In an embodiment, external light may substantially pass through the polarizers 200 and 300 when areas with the same polarizing axis orientation completely overlap each other, so that the transmittance of the display apparatus is its maximum.

In a configuration/operation of the display apparatus illustrated in FIG. 2B, the transmittance of the display apparatus for external light of the display apparatus is medium. Referring to FIG. 2B, the first polarizer 200 may be moved by a second distance (d2) in the first direction D1 with respect to the second polarizer 300. The second distance (d2) may be smaller than the width of each of the areas A1, B1, A2 and B2 in the first direction D1, and larger than zero.

In an embodiment, first areas A1 of the first polarizer 200 may partially overlap first areas B1 and partially overlap second areas B2 of the second polarizer 300. The polarizing axis (first polarizing axis) of a/each first area A1 of the first polarizer 200 is same as the polarizing axis of a/each first area B1 of the second polarizer 300, so that some of the external light may pass through the polarizers 200 and 300. The polarizing axis (the first polarizing axis) of the first area A1 of a/each first polarizer 200 is perpendicular to the polarizing axis (second polarizing axis) of a/each second area B2 of the second polarizer 300, so that some of the external light may be blocked by the polarizers 200 and 300.

Second areas A2 of the first polarizer 200 may partially overlap (and not completely overlap) second areas B2 and first areas B1 of the second polarizer 300. The polarizing axis (the second polarizing axis) of a/each second area A2 of the first polarizer 200 is oriented at a same direction as the polarizing axis of a/each second area B2 of the second polarizer 300, so that external light may substantially pass through the polarizers 200 and 300 wherein areas A2 overlap areas B2. The polarizing axis (the second polarizing axis) of a/each second area A2 of the first polarizer 200 is perpendicular to the polarizing axis (the first polarizing axis) of a/each first area B1 of the second polarizer 300, so that external light may be substantially blocked by the polarizers 200 and 300 where areas A2 overlap areas B1.

In an embodiment, the display apparatus may partially pass/transmit the external light, so that the display apparatus may have a mid-level transmittance, and that the display surface may have a mid-level brightness. The display apparatus may control the transmittance by fine-controlling of the second distance (d2) within a suitable range.

In a configuration/operation of the display apparatus illustrated in FIG. 2C, the transmittance of the display apparatus for external light is its minimum. Referring to FIGS. 2C, the first polarizer 200 may be moved by a third distance (d3) in the first direction D1 with respect to the second polarizer 300. The third distance (d3) may be substantially equal to the width of each of the areas A1, B1, A2, and B2 in the first direction D1.

In an embodiment, first areas A1 of the first polarizer 200 may substantially completely match and/or overlap second areas B2 of the second polarizer 300. Second areas A2 of the first polarizer 200 may substantially completely match and/or overlap first areas B1 of the second polarizer 300.

In an embodiment, external light may not significantly pass through the first polarizer 200 and the second polarizer 300 where overlapping areas have polarizing axes with different orientations, so that external light may be substantially blocked by the polarizer 200 and 300.

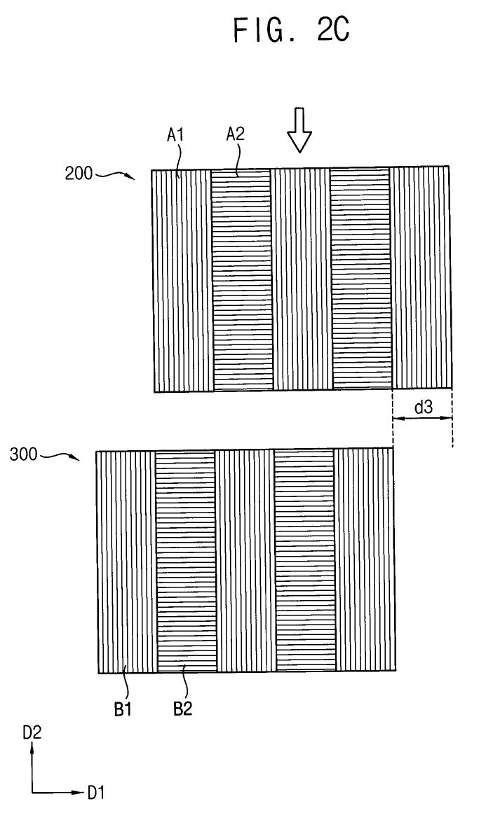

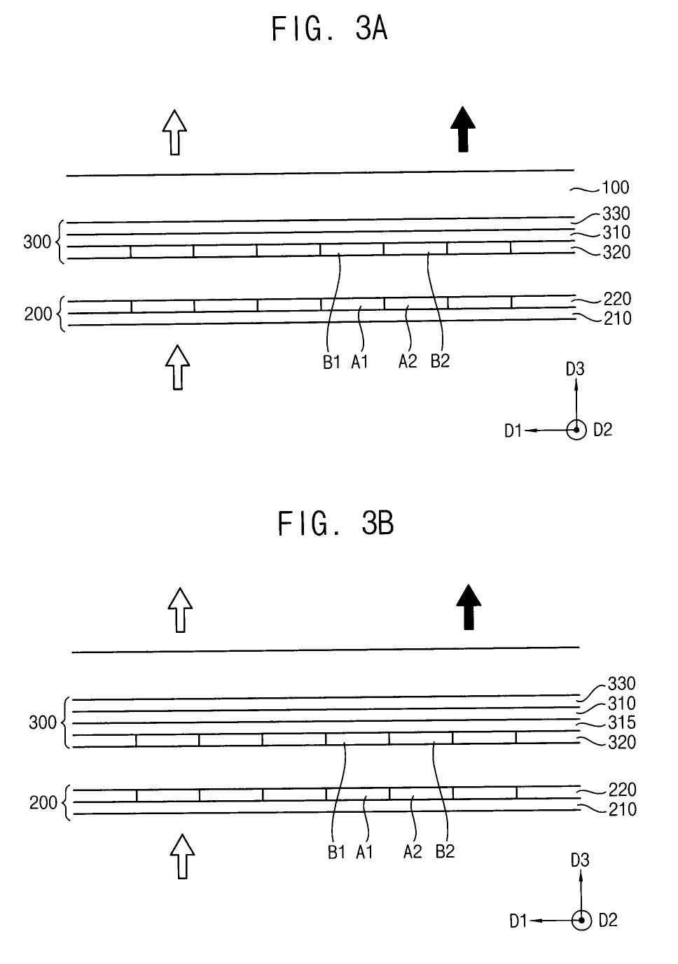

FIG. 3A is a cross-sectional view illustrating the display apparatus of FIG. 1 according to an embodiment.

Referring to FIGS. 1 and 3A, the display apparatus may include a display panel 100, a first polarizer 200, and a second polarizer 300.

The display panel 100 may be a transparent display panel which can pass external light and can display an image according to image data. The display panel 100 may be disposed on a plane which can be defined by a first direction D1 and a second direction D2 which is different from the first direction D1. The second direction D2 may be substantially perpendicular to the first direction D1.

The first polarizer 200 may be disposed on a rear surface of the display panel 100. The first polarizer 200 may include a first base layer 210 and a first polarizing layer 220.

The first base layer 210 may be a transparent film. The first polarizing layer 220 may be disposed on the first base layer 210. The first polarizing layer 220 may include a first area A2 and a second area A2. The first polarizing layer 220 may be directly formed on the first base layer 210 with the areas A1 and A2 having polarizing axes perpendicular to each other. For example, the first polarizer 200 may be one of a wire grid polarizer, a PVA polarizing plate, and etc.

The second polarizer 300 may be attached on the rear surface of the display panel 100. The second polarizer 300 may include a second base layer 310, a second polarizing layer 320, and an adhesive layer 330.

The second base layer 310 may be a transparent film. The second polarizing layer 320 may be disposed on the second base layer 310. The second polarizing layer 320 may include a first area B1 and a second area B2. The second polarizing layer 320 may be directly formed on the second base layer 310 with the areas B1 and B2 having polarizing axes perpendicular to each other. For example, the second polarizer 300 may be one of a wire grid polarizer, a PVA polarizing plate, and etc.

The adhesive layer 330 may be disposed on the second base layer 310. The second polarizer 300 may be attached on the rear surface of the display panel 100 by the adhesive layer 330.

Although the second polarizer 300 is attached on the rear surface of the display panel 100 in an example embodiment, the second polarizer 300 may be attached on a front surface (e.g., an image displaying surface) of the display panel 100 according to another example embodiment. In an embodiment, the display panel 100 may be disposed between the first polarizer 200 and the second polarizer 300.

FIG. 3B is a cross-sectional view illustrating a display apparatus according to an embodiment.

Referring to FIGS. 1 and 3B, the display apparatus may include a display panel 100, a first polarizer 200, and a second polarizer 300.

The display panel 100 may be a transparent display panel which can pass external light and can display an image according to image data. The display panel 100 may be disposed on a plane which can be defined by a first direction D1 and a second direction D2 which is different from the first direction D1. The second direction D2 may be substantially perpendicular to the first direction D1.

The first polarizer 200 may be disposed on a rear surface of the display panel 100. The first polarizer 200 may include a first base layer 210, a first adhesive layer, and a first polarizing layer 220.

The first base layer 210 may be a transparent film. The first polarizing layer 220 may be disposed on the first base layer 210. The first polarizing layer 220 may include a first area A1 and a second area A2. The first polarizing layer 220 may be formed by disposing a plurality of polarizing pieces corresponding to the areas A1 and A2 and having polarizing axes perpendicular to each other, and attaching the first polarizing layer 220 on the first base layer 210 by positioning the first adhesive layer between the first base layer 210 and the first polarizing layer 220.

The second polarizer 300 may be attached on the rear surface of the display panel 100. The second polarizer 300 may include a second base layer 310, a second adhesive layer 315, a second polarizing layer 320, and a third adhesive layer 330.

The second base layer 310 may be a transparent film. The second polarizing layer 320 may be disposed on the second base layer 310. The second polarizing layer 320 may include a first area B1 and a second area B2. The second polarizing layer 320 may be formed by disposing a plurality of polarizing pieces corresponding to the areas B1 and B2 and having polarizing axes perpendicular to each other, and attaching the second polarizing layer 320 on the second base layer 310 by positioning the second adhesive layer 315 between the second base layer 310 and the second polarizing layer 320.

The adhesive layer 330 may be disposed on the second base layer 310. The second polarizer 300 may be attached on the rear surface of the display panel 100 by the adhesive layer 330.

Although the second polarizer 300 is attached on the rear surface of the display panel 100 in an example embodiment, the second polarizer 300 may be attached on a front surface (e.g., an image display surface) of the display panel 100 according to another example embodiment. In an embodiment, the display panel 100 may be disposed between the first polarizer 200 and the second polarizer 300.

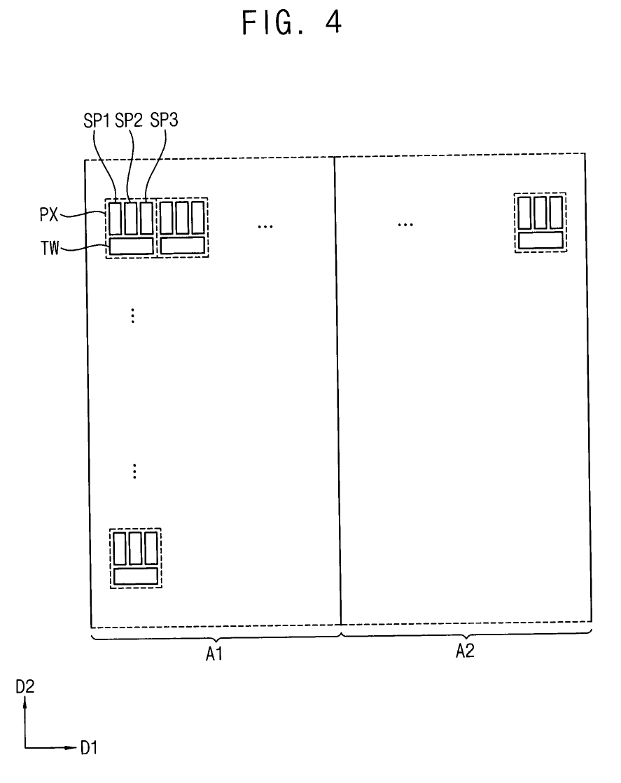

FIG. 4 is a plan view illustrating relationship between first and second areas of a first polarizer and a pixel of a display panel of the display apparatus of FIG. 1 according to an embodiment.

Referring to FIG. 4, the display apparatus may include a plurality of pixels PX to display an image according to received image data. Each of the pixels PX may include a first sub-pixel SP1, a second sub-pixel SP2, a third sub-pixel SP3 and a transmission window TW (e.g., a colorless transparent window).

The sub-pixels SP1, SP2, and SP3 may respectively emit first-color light, second-color light, and third-color light, which are different from each other. For example, the first sub-pixel SP1 may emit red color light, the second sub-pixel SP2 may emit green color light, and the third sub-pixel SP3 may emit blue color light.

The transmission window TW may be transparent to pass external light.

The first area A1 of the first polarizer may extend in a second direction D2 which is substantially perpendicular to a first direction D1 and may be longer in the second direction D2 than in the first direction D1. The second area A2 may directly contact/abut the first area A1 in the first direction D1, may extend in the second direction D2, and may be longer in the second direction D2 than in the first direction D1.

In a plan view of the display apparatus, a plurality of pixels PX may be disposed in each of the first area A1 and the second area A2 of the first polarizer. In an embodiment, a plurality of pixels PX may be disposed in the first area A1 along the first direction D1. A plurality of pixels PX may be disposed in the first second A2 along the first direction D1. Sub-pixels of each pixel PX may be arranged along the first direction D1.

In an embodiment, exactly one pixel may be disposed within a width of each first area A1 in the first direction D1. In an embodiment, a plurality of pixels PX may be disposed within a width of each first area A1 in the first direction D1. Generally, horizontal and vertical sizes of one pixel PX may be several tens of micrometers to hundreds of micrometers, for example about 150 micrometers. In an embodiment, width of the first area A1 in the first direction D1 may be hundreds of micrometers to several tens of millimeters.

In an embodiment, the width of the first area A1 in the first direction D1 may be determined in consideration of manufacturing requirements and functional requirements. In an embodiment, the width is determined to satisfy that stripe formed at a boundary of the first area A1 and the second area A2 is not visible to user.

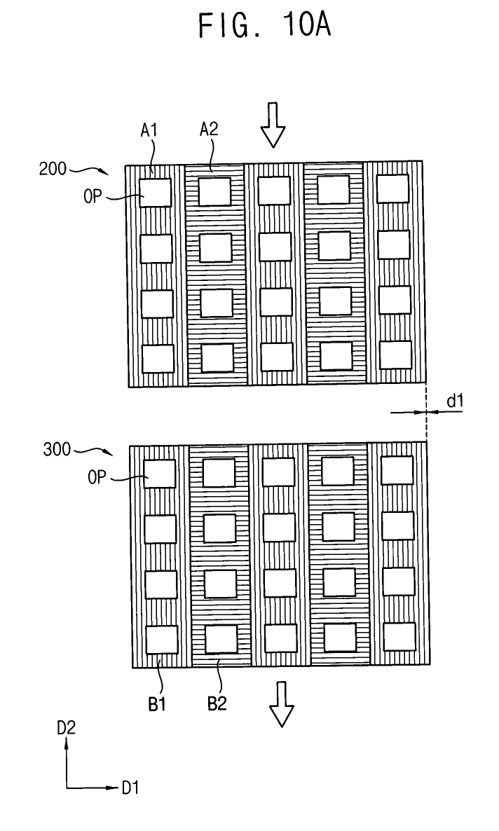

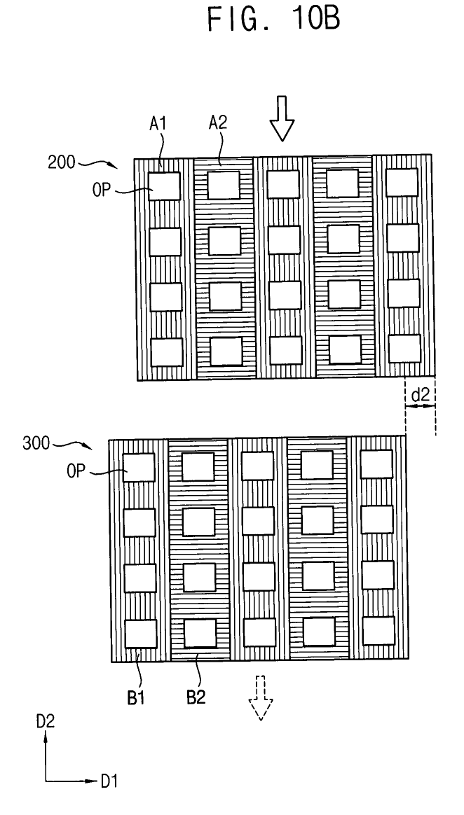

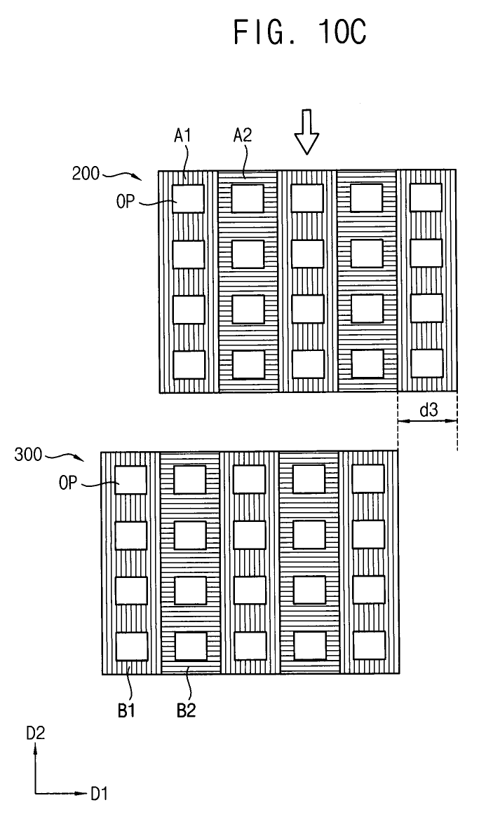

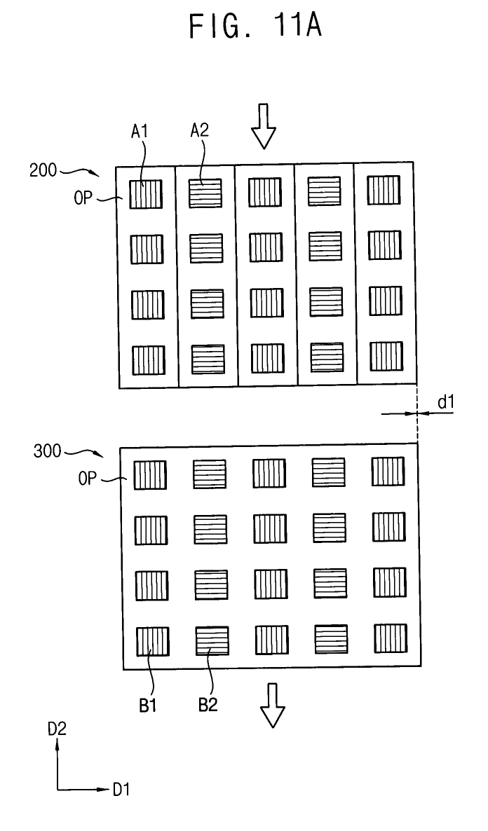

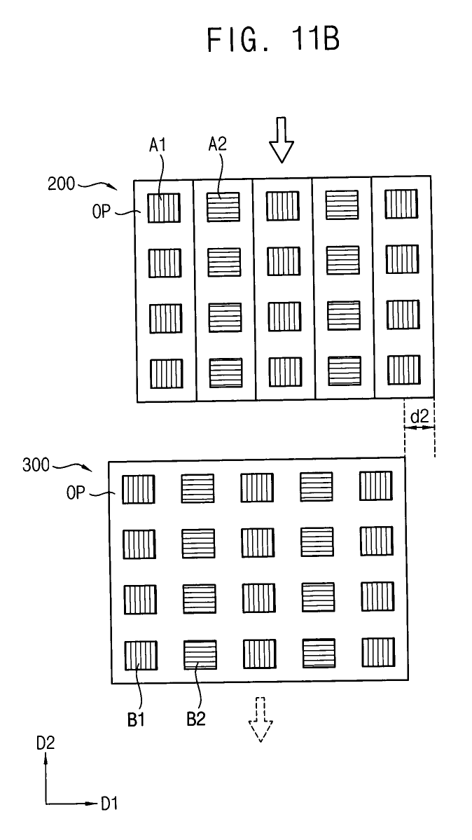

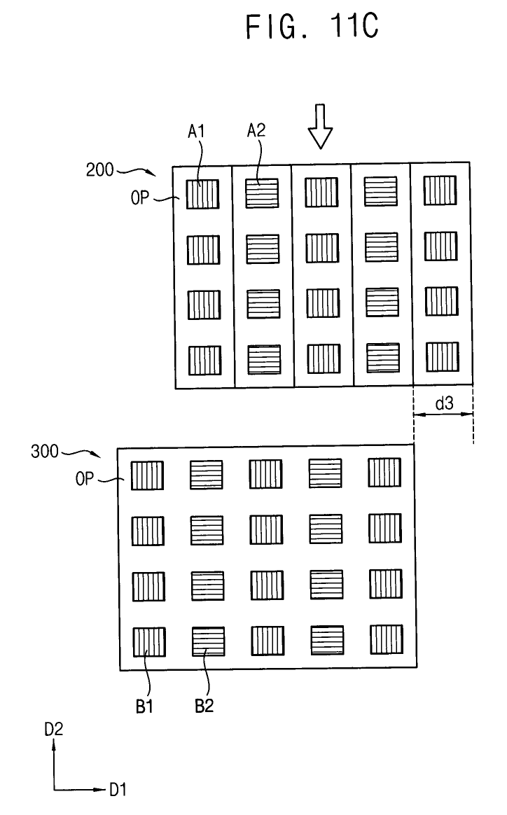

In some embodiment, one or more of areas A1 and A2 may include non-polarizing openings OP (not shown in figures, refers to OP illustrated in one or more of FIGS. 10A, 10B, 10C, 11A, 11B, and 11C). The non-polarizing openings may correspond to the transmission windows TW and may be positioned on transmission windows TW, for optimizing use of external light.

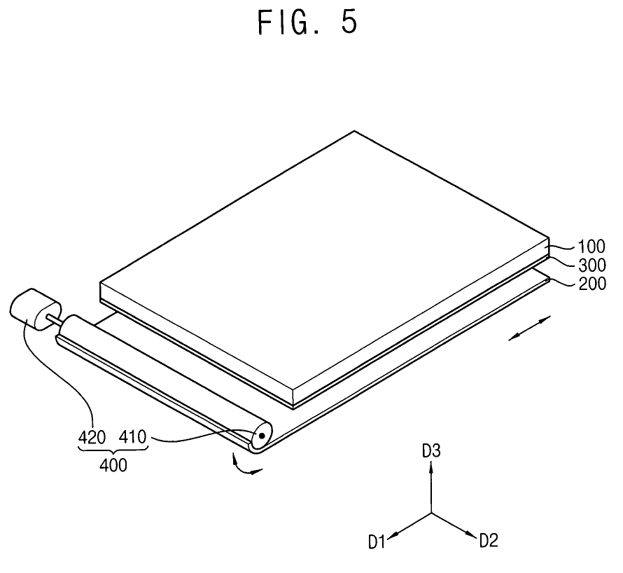

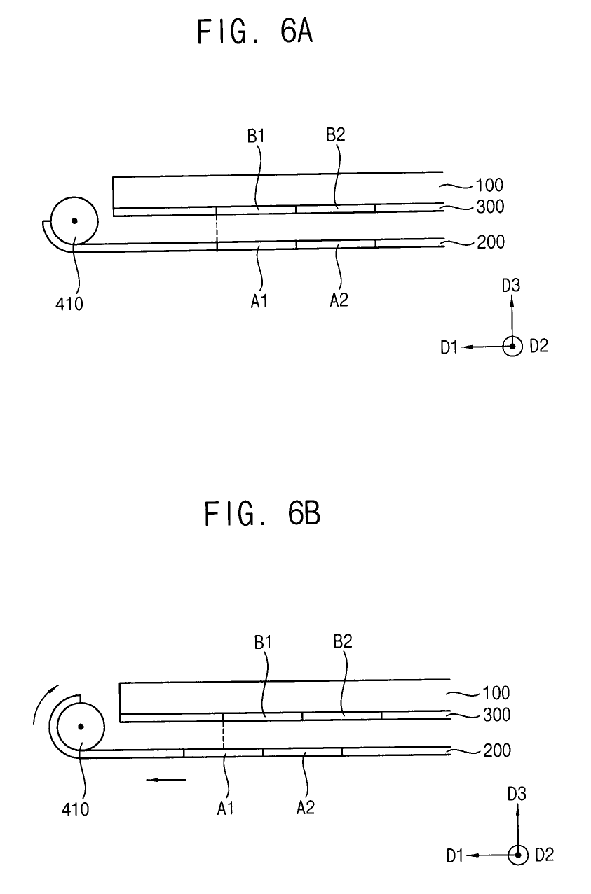

FIG. 5 is a conceptual perspective view illustrating a driving part of a display apparatus according to an embodiment. FIGS. 6A and 6B are cross-sectional views illustrating an operation of the driving part of FIG. 5 according to an embodiment.

Referring to FIGS. 5, 6A, and 6B, the display apparatus may include a display panel 100, a first polarizer 200, a second polarizer 300, and a driving part 400.

The display panel 100 may be a transparent display panel which passes external light and displays an image. The display panel 100 may be disposed on a plane which can be defined by a first direction D1 and a second direction D2 which is different from the first direction D1. The second direction D2 may be substantially perpendicular to the first direction D1.

The first polarizer 200 may be disposed on a rear surface of the display panel 100. In an embodiment, the first polarizer 200 may be spaced from the display panel 100 in a third direction D3. The third direction D3 may be substantially perpendicular to the directions D1 and D2. The first polarizer 200 may include a plurality of polarizing areas A1 and A2 which are alternately disposed.

The second polarizer 300 may be attached on the rear surface of the display panel 100, and disposed between the display panel 100 and the first polarizer 200. The second polarizer 300 may include a plurality of polarizing areas B1 and B2 which are alternately disposed.

The driving part 400 is configured to automatically move the first polarizer 200 in the first direction D1.

The driving part 400 may include a roll 410 and a driving motor 420. The roll 410 may be attached on an end of the first polarizer 200. According to rotation of the roll 410 by the driving motor 420, the end of the first polarizer 200 can be further bent, and/or rolled onto the roll 410, so that the first polarizer 200 may move along the first direction D1. In an embodiment, the display apparatus may further include a guide which guides the first polarizer 200 to be moved in a plane defined by the directions D1 and D2.

Referring again to FIG. 6A, a first area A1 and a second area A2 of the first polarizer 200 may be disposed or moved to respectively overlap and/or match a first area B1 and a second area B2 of the second polarizer 300. In an embodiment, the first area A1 of the first polarizer 200 may substantially completely overlap the first area B1 of the second polarizer 300, and the second area A2 of the first polarizer 200 may substantially completely overlap the second area B2 of the second polarizer 300.

Referring again to FIG. 6B, as the driving motor 420 of the driving part 400 operates, the roll 410 rotates and the first polarizer 200 moves in the first direction D1. As a result, a position of the first polarizer 200 relative to the second polarizer 300 may be changed.

In an embodiment, the first area A1 of the first polarizer 200 may partially (not substantially completely) overlap the first area B1 of the second polarizer 300. The second area A2 of the first polarizer 200 may partially (not substantially completely) overlap the first area B1 of the second polarizer 300 and may partially (not substantially completely) overlap the second area B2.

In an embodiment, the display apparatus may further include a sensing unit (not shown in figures) for sensing strength of external light. The sensing unit may be electrically connected to the driving part 400 and may provide a light strength measurement to the driving part 400. The sensing unit and the driving part 400 may control the transmittance of the display apparatus according to the light strength measurement of the external light. For example, when the external light is strong, the driving part 400 may move the first polarizer 200 to decrease the transmittance of the display apparatus. In an embodiment, when the external light is weak, the driving part 400 may move the first polarizer 200 to increase the transmittance of the display apparatus.

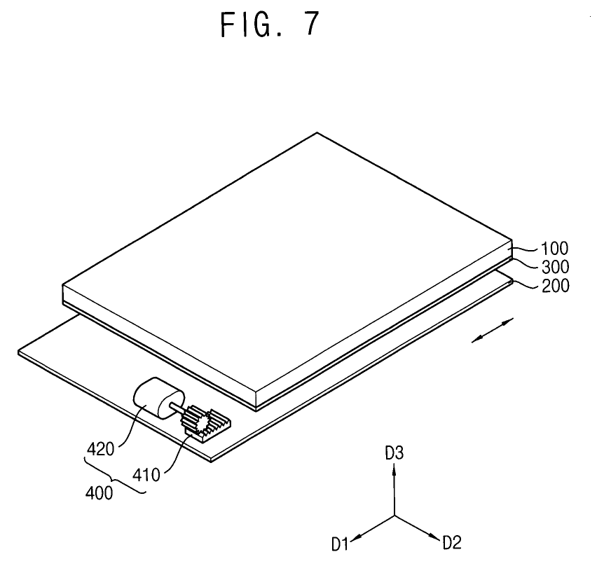

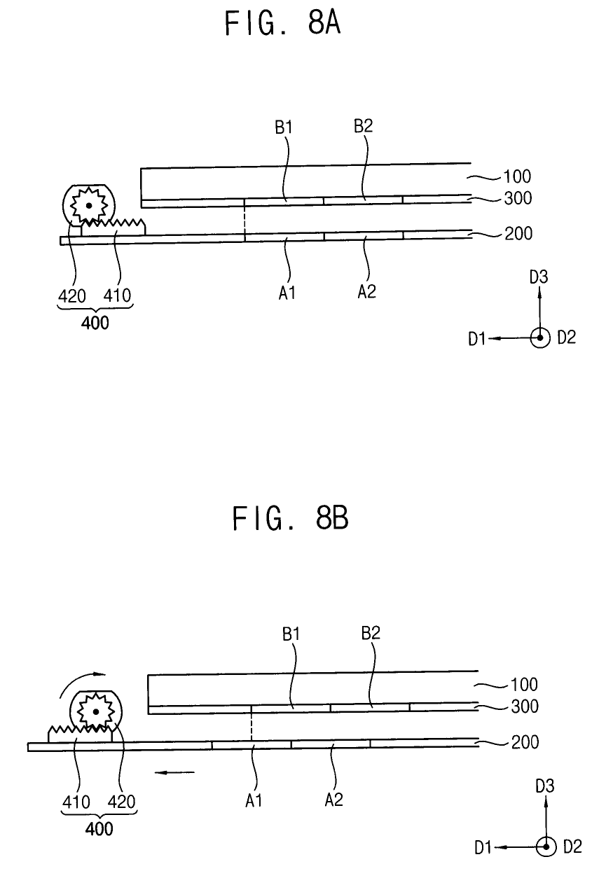

FIG. 7 is a conceptual perspective view illustrating a driving part of a display apparatus according to an embodiment. FIGS. 8A and 8B are cross-sectional views illustrating an operation of the driving part of FIG. 7 according to an embodiment.

Referring to FIGS. 7, 8A, and 8B, the display apparatus may include elements substantially identical to or analogous to elements discussed with reference to one of more of other figures, e.g., one or more of FIGS. 5, 6A, and 6B. Descriptions concerning identical elements and/or identical elements may not be repeated.

The display apparatus may include a display panel 100, a first polarizer 200, a second polarizer 300, and a driving part 400.

The driving part 400 is configured to move the first polarizer 200 along the first direction D1 on a plane define by the directions D1 and D2.

The driving part 400 may include a driving motor 420 and a pinion gear. The polarizer 200 may include a rack gear 410. The rack gear 410 may be positioned at an end of the first polarizer 200 and may directly contact/engage the pinion gear. The rack gear 410 may be attached to one or more of layers 210 and 220 illustrated in one or more of FIGS. 3A and 3B. As the pinion gear is rotated by the driving motor 420, the rack gear 410 moves to move the first polarizer 200 in the first direction D1. In an embodiment, the display apparatus may further include a guide which guides the first polarizer 200 to be moved in the plane defined by the first and second directions D1 and D2.

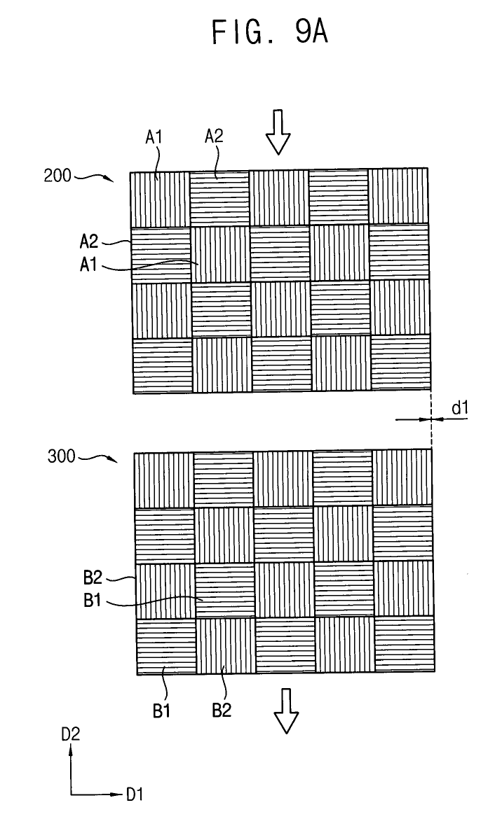

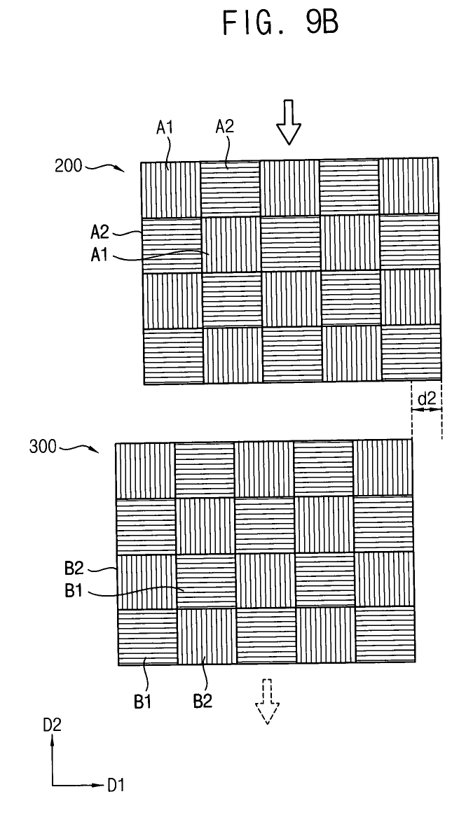

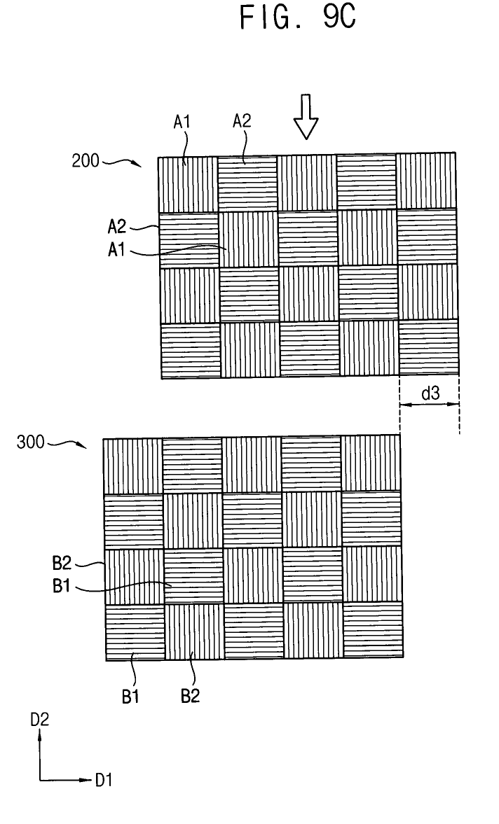

FIGS. 9A, 9B, and 9C are plan views illustrating a first polarizer and a second polarizer of a display apparatus according to an embodiment.

Referring to FIGS. 9A to 9C, the display apparatus, the polarizer 200, and/or the polarizer 300 may include elements that are substantially identical or analogous to element described with reference to one or more other figures, e.g., one or more of FIGS. 2A to 2C. Descriptions concerning substantially identical elements and/or analogous elements may not be repeated.

In a configuration/operation of the display apparatus illustrated in FIG. 9A, transmittance of the display apparatus for external light is its maximum. Referring to FIG. 9A, light passing through the first polarizer 200 may be polarized. The first polarizer 200 may include a plurality of first areas A1 and a plurality of second areas A2. The polarizing axis direction of the areas A1 is different from the polarizing axis direction of the areas A2. The first areas A1 and the second areas A2 may be alternately disposed in the first direction D1 and in a second direction D2 which is substantially perpendicular to the first direction D1. In an embodiment, the first areas A1 and the second areas A2 may be arranged in a grid pattern and/or a checkerboard pattern.

Light passing the second polarizer 300 may be polarized. The second polarizer 300 may include a plurality of first areas B1 and a plurality of second areas B2. The first areas B1 and the second areas B2 may be alternately disposed in the first direction D1 and in the second direction D2. In an embodiment, the first areas B1 and the second areas B2 may be arranged in a grid pattern and/or a checkerboard pattern.

Sizes of the areas A1, A2, B1, and B2 may be substantially equal to one another. Shapes of the areas A1, A2, B1, and B2 may be substantially identical to one another. Each of the areas A1, A2, B1, and B2 may have a square shape having equal-length edges in a plan view of the display apparatus.

In a configuration/operation of the display apparatus illustrated in FIG. 9B, the transmittance of the display apparatus for external light is medium. In a configuration/operation of the display apparatus illustrated in FIG. 9C, the transmittance of the display apparatus for external light is its minimum.

According to an example embodiment, the areas A1 and A2 are alternately disposed to form a grid/checkerboard pattern, and the areas B1 and B2 are alternately disposed to form a grid/checkerboard pattern. Advantageously, stripes formed at A1-A2 boundaries and B1-B2 boundaries may be substantially invisible or unnoticeable to users even when the transmittance of the display apparatus is changed,

FIGS. 10A, 10B, and 10C are plan views illustrating a first polarizer and a second polarizer of display apparatus according to an embodiment.

Referring to FIGS. 10A to 10C, the display apparatus, the first polarizer 200, and/or the second polarizer 300 may include elements that are substantially identical or analogous to element described with reference to one or more other figures, e.g., one or more of FIGS. 2A to 3A. Descriptions concerning substantially identical elements and/or analogous elements may not be repeated.

In a configuration/operation of the display apparatus illustrated in FIG. 10A, transmittance of the display apparatus for external light is its maximum. Referring to FIG. 10A, light passing through the first polarizer 200 may be polarized. The first polarizer 200 may include a plurality of first areas A1 and a plurality of second areas A2. The polarizing axis direction of the areas A1 is different from the polarizing axis direction of the areas A2. The first areas A1 may extend in a second direction D2. The second direction D2 may be substantially perpendicular to the first direction D1. Second area A2 may directly contact/abut first areas A1 in the first direction D1 and may extend in the second direction D2. A width of a/each first area A1 may be substantially equal to a width of a/each second area A2 in the first direction D1.

A plurality of non-polarizing openings OP may be formed in the first areas A1 and the second areas A2. The openings OP may be arranged at regular intervals. The openings OP may have same shape and size. The openings OP may correspond to and/or may be positioned on transmission windows TW of the display panel 100.

Light passing the second polarizer 300 may be polarized. The second polarizer 300 may include a plurality of first areas B1 and a plurality of second areas B2. The polarizing axis direction of the areas B1 is different from the polarizing axis direction of the areas B2. The first areas B1 may extend in the second direction D2. Second areas B2 may directly contact/abut first areas B1 in the first direction D1 and may extend in the second direction D2. The first area B1 and the second area B2 may have substantially same width in the first direction D1. Shapes of the areas A1, A2, B1, and B2 may be substantially identical to one another. Sizes of the areas A1, A2, B1, and B2 may be substantially equal to one another.

A plurality of non-polarizing openings OP may be formed in each first area B1 and each second area B2. The openings OP may be arranged at regular intervals, and the openings OP may have same shape and size. The openings OP may correspond to and/or may be positioned on transmission windows TW of the display panel 100.

The openings OP of the first polarizer 200 may respectively correspond to and/or may be respectively positioned on the openings OP of the second polarizer 300.

In an embodiment, the openings OP of the second polarizer 300 and the openings OP of the first polarizer 200 may be positioned on transmission portions TW of the display panel 100, so that transmittance of the display apparatus may be optimized. The size of the openings OP may be configured and/or controlled according to required transmittance.

In a configuration/operation of the display apparatus illustrated in FIG. 10B, the transmittance of the display apparatus for external light is medium. In a configuration/operation of the display apparatus illustrated in FIG. 10C, the transmittance of the display apparatus for external light is its minimum.

FIGS. 11A, FIG. 11B, and 11C are plan views illustrating a first polarizer and a second polarizer of a display apparatus according to an embodiment.

Referring to FIGS. 11A to 11C, the display apparatus, the polarizer 200, and/or the polarizer 300 may include elements that are substantially identical or analogous to element described with reference to one or more other figures, e.g., one or more of FIGS. 2A to 2C. Descriptions concerning substantially identical elements and/or analogous elements may not be repeated.

Referring to FIG. 11A, transmittance of the display apparatus for external light is its maximum. Referring to FIG. 11A, light passing through the first polarizer 200 may be polarized. The first polarizer 200 may include a plurality of first areas A1 and a plurality of second areas A2. The polarizing axis direction of the areas A1 is different from the polarizing axis direction of the areas A2. A plurality of first areas A1 may be arranged (and aligned) in a second direction. The second direction D2 may be substantially perpendicular to a first direction D1. A plurality of the second areas A2 may be spaced from the first area A1 in the first direction D1 and may be arranged (and aligned) in the second direction D2. The first area A1 and the second area A2 may have same width in the first direction D1. Light passing through a non-polarizing opening OP between a first area A1 and an immediately neighboring second area A2 is not polarized, so that transmittance of the display apparatus may be optimized. By controlling and/or configuring sizes of the first areas A1 and the second areas A2, required transmittance can be obtained.

Light passing the second polarizer 300 may be polarized. The second polarizer 300 may include a plurality of first areas B1 and a plurality of second areas B2. A plurality of the first areas B1 may be arranged (and aligned) in the second direction D2. A plurality of the second areas B2 may be spaced from the first area B1 in the first direction D1 and may be arranged (and aligned) in the second direction D2. The first area B1 and the second area B2 may have same width in the first direction D1. Shapes of the areas A1, A2, B1, and B2 may be substantially identical to one another. Sizes of the areas A1, A2, B1, and B2 may be substantially equal to one another.

In a configuration/operation of the display apparatus illustrated in FIG. 11B, the transmittance of the display apparatus for external light is medium. In a configuration/operation of the display apparatus illustrated in FIG. 11C, the transmittance of the display apparatus for external light is its minimum.

According to example embodiments, a display apparatus may include a display panel, a first polarizer, and a second polarizer. The display panel may display an image according to image data. The display apparatus may control transmittance of the display apparatus by changing relative position of the first polarizer and the second polarizer. In an embodiment, when external light is strong, the transmittance of the display apparatus may be decreased, so that visibility of the image displayed on the display apparatus may be optimized.

The foregoing is illustrative and is not to be construed as limiting. Although a few embodiments have been described, those skilled in the art will readily appreciate that many modifications are possible in the embodiments. All such modifications are intended to be included within the scope defined in the claims. In the claims, means-plus-function clauses are intended to cover the structures described herein as performing the recited function and not only structural equivalents but also equivalent structures.

What is claimed is:

1. A display apparatus comprising:
a display panel having a display surface and configured to display an image on the display surface;
a first polarizer positioned on the display panel;
a second polarizer positioned on the display panel and overlapping the first polarizer; and
a driving part configured to move the first polarizer in a first direction, wherein the first direction is parallel to the display surface.

2. The display apparatus of claim 1,
wherein the first polarizer comprises first-polarizer first-type portions and first-polarizer second-type portions,
wherein the first-polarizer first-type portions and the first-polarizer second-type portions are alternately positioned,
wherein polarizing axes of the first-polarizer first-type portions are perpendicular to polarizing axes of the first-polarizer second-type portions,
wherein the second polarizer comprises second-polarizer first-type portions and second-polarizer second-type portions,
wherein the second-polarizer first-type portions and the second-polarizer second-type portions are alternately positioned, and
wherein polarizing axes of the second-polarizer first-type portions are perpendicular to polarizing axes of the second-polarizer second-type portions.

3. The display apparatus of claim 2, wherein a first subset of the first-polarizer first-type portions and a first subset of the first-polarizer second-type portions are alternately positioned along the first direction.

4. The display apparatus of claim 3,
wherein a second direction is parallel to the display surface and is perpendicular to the first direction, and
wherein a second subset of the first-polarizer first-type portions and a second subset of the first-polarizer second-type portions are alternately positioned along the second direction.

5. The display apparatus of claim 2,
wherein a second direction is parallel to the display surface and is perpendicular to the first direction,
wherein the first-polarizer first-type portions include a first first-polarizer first-type portion,
wherein a first edge of the first first-polarizer first-type portion extends in the first direction,
wherein a second edge of the first first-polarizer first-type portion extends in the second direction and is longer than or as long as the first edge of the first first-polarizer first-type portion,
wherein the first-polarizer second-type portions include a first first-polarizer second-type portion,
wherein a first edge of the first first-polarizer second-type portion extends in the first direction, and
wherein a second edge of the first first-polarizer second-type portion extends in the second direction and is longer than or as long as the first edge of the first first-polarizer second-type portion.

6. The display apparatus of claim 5, wherein the second edge of the first first-polarizer second-type portion is longer than the first edge of the first first-polarizer second-type portion.

7. The display apparatus of claim 6, wherein the first first-polarizer second-type portion has a non-polarizing opening.

8. The display apparatus of claim 7,
wherein the display panel comprises a pixel,
wherein the pixel comprises light emitting structure and a transparent window,
wherein the light emitting structure neighbors the transparent window in a plan view of the display apparatus, and
wherein the non-polarizing opening is positioned on the transparent window.

9. The display apparatus of claim 5, wherein the second edge of the first first-polarizer second-type portion is as long as the first edge of the first first-polarizer second-type portion.

10. The display apparatus of claim 5, wherein the second edge of the first first-polarizer second-type portion abuts the second edge of the first first-polarizer first-type portion.

11. The display apparatus of claim 5, wherein the second edge of the first first-polarizer second-type portion is spaced from the second edge of the first first-polarizer second-type portion, and wherein no intervening polarizing portion is positioned between the second edge of the first first-polarizer second-type portion and the second edge of the first first-polarizer first-type portion.

12. The display apparatus of claim 11,
wherein the display panel comprises a pixel,
wherein the pixel comprises light emitting structure and a transparent window,
wherein the light emitting structure neighbors the transparent window in a plan view of the display apparatus, and
wherein a non-polarizing opening is positioned between the second edge of the first first-polarizer second-type portion and the second edge of the first first-polarizer first-type portion and is positioned on the transparent window.

13. The display apparatus of claim 5,
wherein the display panel comprises a pixel,
wherein the pixel comprises light emitting structure and a transparent window,
wherein the light emitting structure neighbors the transparent window in a plan view of the display apparatus,
wherein the first-polarizer first-type portions include a second first-polarizer first-type portion,
wherein a non-polarizing opening is positioned between the first first-polarizer first-type portion and the second first-polarizer first-type portion and is positioned on the transparent window.

14. The display apparatus of claim 5,
wherein the display panel comprises a first pixel and a second pixel,
wherein the first pixel comprises first light emitting structure and a first transparent window,
wherein the first light emitting structure neighbors the first transparent window in a plan view of the display apparatus,
wherein the second pixel comprises second light emitting structure and a second transparent window,
wherein the second light emitting structure neighbors the second transparent window in a plan view of the display apparatus,
wherein the first first-polarizer first-type portion has or abuts a first non-polarizing opening,
wherein the first non-polarizing opening is position on the first transparent portion,
wherein the first first-polarizer second-type portion has or abuts a second non-polarizing opening,
wherein the second non-polarizing opening is position on the second transparent portion, and
wherein the second edge of the first first-polarizer first-type portion and the second edge of the first first-polarizer second-type portion are positioned between the first non-polarizing opening and the second non-polarizing opening in the plan view of the display apparatus.

15. The display apparatus of claim 14,
wherein the first first-polarizer first-type portion is spaced from the first first-polarizer second-type portion, and
wherein no intervening polarizing portion is positioned between the first first-polarizer first-type portion and the first first-polarizer second-type portion.

16. The display apparatus of claim 1, wherein the driving part is configured to bend a portion of the first polarizer for moving the first polarizer.

17. The display apparatus of claim 1,
wherein the first polarizer comprises a rack gear,
wherein the driving part comprises a pinion gear, and
wherein the pinion gear directly contacts the rack gear.

18. The display apparatus of claim 1, wherein the second polarizer is positioned between the display panel and the first polarizer.

19. The display apparatus of claim 1 comprising: a sensing unit electrically connected to the driving part and configured to determine a light strength measurement associated with light received by the sensing unit, and wherein the driving part is configured to move the first polarizer according to the light strength measurement.

20. A display apparatus, comprising:
a transparent display panel configured to display an image on a plane which is formed by a first direction and a second direction perpendicular to the first direction, and configured to pass external light;
a first polarizer disposed on the transparent display panel and configured to be physically movable in the first direction; and
a second polarizer disposed on the transparent display panel and overlapping the first polarizer.
